(19) United States
(12) Patent Application Publication
(10) Pub. No.: US 2022/0029849 A1
(43) Pub. Date: Jan. 27, 2022

(54) ELECTRONIC DEVICE, METHOD AND STORAGE MEDIUM FOR MONITORING CONNECTION STATE OF CLIENT DEVICES

(71) Applicant: ARRIS Enterprises LLC, Suwanee, GA (US)

(72) Inventor: Xin WANG, Shenzhen (CN)

(21) Appl. No.: 17/320,872

(22) Filed: May 14, 2021

(51) Int. Cl. H04L 12/28

(52) U.S. Cl. CPC H04L 12/2809; H04L 12/2816; H04L 2012/285; H04L 12/2834; H04L 12/2812

(57) ABSTRACT

An electronic device, method and storage medium for monitoring a connection state of a client device. The electronic device includes a memory and a processor, the memory having instructions stored thereon, the processor being configured to execute the instructions stored on the memory, to cause the electronic device to perform operations comprising: determining whether a client device needs to be always online according to a predetermined rule; in response to determining that the client device needs to be always online, adding the client device to a first list; monitoring a connection state of a listed client device in the first list; and sending an alert to the user in response to determining that the listed client device in the first list is offline.

### FIELD OF THE INVENTION

The present disclosure relates to an electronic device, method, storage medium and apparatus for monitoring connection state of client devices.

### BACKGROUND

In scenarios such as Smart Home or Smart Office, client devices in a home or work space are connected to a network, so that users can remotely control these devices through the network whenever and wherever desired. If the connection between these client devices and the network fails (for example, the connection is disconnected), the user needs to actively discover the failure, which is not easy for the user; and in the case where the user cannot discover the failure and restore the connection in time, it will become very inconvenient when the user wants to control these client devices (especially those that need to maintain a connection to the network, such as a surveillance camera), which will affect the use of these devices.

### SUMMARY

Some aspects of the present disclosure relate to an electronic device including a memory and a processor, the memory having instructions stored thereon, the processor being configured to execute the instructions stored on the memory, to cause the electronic device to perform at least the following operations: determining whether a client device needs to be always online according to a predetermined rule; in response to determining that the client device needs to be always online, adding the client device to a first list; monitoring a connection state of a listed client device in the first list; and sending an alert to the user in response to determining that the listed client device in the first list is offline.

In some embodiments, for the electronic device described above, the determining whether the client device needs to be always online according to a predetermined rule includes: recording an online time of the client device; and determining that the client device needs to be always online if the online time of the client device exceeds a predetermined threshold.

In some embodiments, for the electronic device described above, the determining whether the client device needs to be always online according to a predetermined rule includes: acquiring device information of the client device; and determining whether the client device needs to be always online based on the acquired device information.

In some embodiments, for the electronic device described above, the determining whether the client device needs to be always online according to a predetermined rule includes: receiving an input from the user, the input indicating whether the client device needs to be always online.

In some embodiments, for the electronic device described above, the sending of an alert to the user includes sending an alert to the user through one or more of an email, a voice message, or a call.

In some embodiments, for the electronic device described above, the processor further causes the electronic device to perform the following operations: receiving an indication to enable or disable monitoring of a connection state of a client device, the indication being given by one or more of: setting the electronic device on a setup webpage or application, or notifying a network service provider through protocol signaling.

In some embodiments, for the electronic device described above, the client device includes one or more of: a smart stereo system, a webcam, a lighting device, a smart refrigerator, or a smart air conditioner.

In some embodiments, for the electronic device described above, the client device needs to be always online includes one of: the client device needs to be always connected to a Wide Area Network (WAN), the client device needs to be always connected to a Local Area Network (LAN), and the monitoring of the connection state respectively includes monitoring whether the listed client device is connected to the WAN or monitoring whether the listed client device is connected to the LAN.

Other aspects of the present disclosure relate to a method for monitoring a connection state of a client device, the method including determining whether a client device needs to be always online according to a predetermined rule; in response to determining that the client device needs to be always online, adding the client device to a first list; monitoring a connection state of a listed client device in the first list; and sending an alert to the user in response to determining that the listed client device in the first list is offline, wherein the above method is performed by an electronic device.

In some embodiments, in the above method, the determining whether the client device needs to be always online according to a predetermined rule includes: recording an online time of the client device; and determining that the client device needs to be always online if the online time of the client device exceeds a predetermined threshold.

In some embodiments, in the above method, the determining whether the client device needs to be always online according to a predetermined rule includes: acquiring device information of the client device; and determining whether the client device needs to be always online based on the acquired device information.

In some embodiments, in the above method, the determining whether the client device needs to be always online according to a predetermined rule includes: receiving an input from the user, the input indicating whether the client device needs to be always online.

In some embodiments, in the above method, the sending of an alert to the user includes: sending an alert to the user through one or more of an email, a voice message, or a call.

In some embodiments, the above method further comprises receiving an indication to enable or disable monitoring of a connection state of a client device, the indication being given by one or more of: setting the electronic device on a setup webpage or application, or notifying a network service provider through protocol signaling.

In some embodiments, in the above method, the client device includes one or more of: a smart stereo system, a webcam, a lighting device, a smart refrigerator, or a smart air conditioner.

In some embodiments, in the above method, the client device needs to be always online includes one of: the client device needs to be always connected to a Wide Area Network (WAN), the client device needs to be always connected to a Local Area Network (LAN), and the monitoring of the connection state respectively includes monitoring whether the listed client device is connected to the WAN or monitoring whether the listed client device is connected to the LAN.

Other aspects of the present disclosure relate to a non-transitory computer-readable medium having instructions stored thereon that, when executed by a processor of an electronic device, cause the processor to perform at least the following operations: determining whether a client device needs to be always online according to a predetermined rule; in response to determining that the client device needs to be always online, adding the client device to a first list; monitoring a connection state of a listed client device in the first list; and sending an alert to the user in response to determining that the listed client device in the first list is offline.

In some embodiments, for the non-transitory computer-readable medium described above, the determining whether the client device needs to be always online according to a predetermined rule includes: recording an online time of the client device; and determining that the client device needs to be always online if the online time of the client device exceeds a predetermined threshold.

In some embodiments, for the non-transitory computer-readable medium described above, the determining whether a client device needs to be always online according to a predetermined rule includes: acquiring device information of the client device; and determining whether the client device needs to be always online based on the acquired device information.

In some embodiments, for the non-transitory computer-readable medium described above, the determining whether the client device needs to be always online according to a predetermined rule includes: receiving an input from the user, the input indicating whether the client device needs to be always online.

In some embodiments, for the non-transitory computer-readable medium described above, the sending of an alert to the user includes: sending an alert to the user through one or more of an email, a voice message, or a call.

In some embodiments, the non-transitory computer-readable medium described above further comprises instructions that cause the processor to perform the following operations: receiving an indication to enable or disable monitoring of a connection state of client devices, the indication being given by one or more of: setting the electronic device on a setup webpage or application, or notifying a network service provider through protocol signaling.

In some embodiments, for the non-transitory computer-readable medium described above, the client device includes one or more of: a smart stereo system, a webcam, a lighting device, a smart refrigerator, or a smart air conditioner.

In some embodiments, for the non-transitory computer-readable medium described above, the client device needs to be always online includes one of: the client device needs to be always connected to a Wide Area Network (WAN), the client device needs to be always connected to a Local Area Network (LAN), and the monitoring of the connection state respectively includes monitoring whether the listed client device is connected to the WAN or monitoring whether the listed client device is connected to the LAN.

Other aspects of the present disclosure relate to an apparatus for monitoring a connection state of a client device, which may include means for performing operations according to the method of the present disclosure.

### BRIEF DESCRIPTION OF THE DRAWINGS

In order to better understand the present disclosure and show how to implement the present disclosure, a description will be given by way of example with reference to the accompanying drawings, in which:

FIG. 1 is a schematic diagram illustrating an example network environment according to an embodiment of the present disclosure;

FIG. 2 is a schematic diagram illustrating an electronic device according to an embodiment of the present disclosure.

FIG. 3 is a method for monitoring a connection state of a client device according to an embodiment of the present disclosure;

FIG. 4 is a method for monitoring a connection state of a client device according to an embodiment of the present disclosure;

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those ordinary skilled in the art will recognize that various changes and modifications of the examples described herein can be made without departing from the spirit and scope of the present disclosure.

As described above, in the prior art, in scenarios such as Smart Home or Smart Office, if the connection between client devices and a network fails in a home or work space (for example, the connection is disconnected), users need to actively discover the failure, which is not easy for users; in the case where a user cannot discover the failure and restore the connection in time, it will become very inconvenient when the user wants to control these client devices (especially those that need to maintain a connection to the network, such as a surveillance camera), which will affect the use of these devices.

According to an embodiment of the present disclosure, an electronic device can be used to monitor a client device's connection state and send an alert to the user when it is detected that the client device is offline, thereby assisting in maintaining the network connection of a client device in time, and making it convenient for the user to control the client devices whenever and wherever desired.

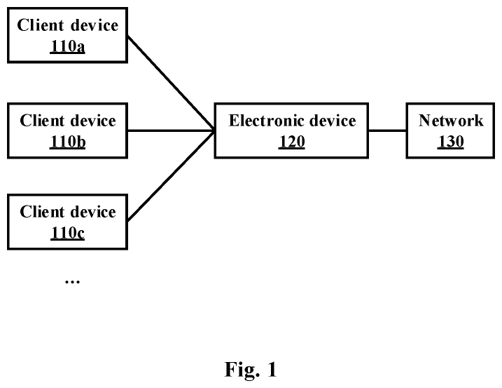

FIG. 1 is a schematic diagram illustrating an example network environment 100 according to an embodiment of the present disclosure.

In some embodiments, the example network environment 100 may include one or more client devices 110a, 110b, 110c (hereinafter, collectively referred to as client devices 110 for simplicity), an electronic device 120, and a network 130. In some embodiments, the client devices 110 access the network 130 through the electronic device 120. In some embodiments, the electronic device 120 may receive/route various types of communications from the client devices 110 and/or transmit/route various types of communications to the client devices 110. For example, one or more client devices 110 may receive one or more data services, one or more audio/video services, one or more home security services, and/or other services through the electronic device 120. For example, in a scenario such as Smart Home, client devices 110 access the network 130 through the electronic device 120, so that a user can remotely control and use these client devices 110.

In some embodiments, the client devices 110 may include various types of devices, including but not limited to a smart stereo system, a webcam, a lighting device, a smart refrigerator, or a smart air conditioner, or any other type of smart home equipment or smart office equipment that can send and/or receive communications in various ways. Some of these client devices may need to maintain a connection to the network to facilitate users to remotely control and use these client devices at any time. For example, a webcam/surveillance camera may need to maintain a connection to the network so that a user can use the camera to monitor the situation of a corresponding location at any time; for another example, in certain seasons such as summer and winter, a smart air conditioner needs to maintain a connection to the network, so that a user can control the temperature in a corresponding space in advance through the smart air conditioner before entering a residential/office, and/or remotely turn off its corresponding temperature control function after leaving the residential/office.

In some embodiments, the electronic device 120 may be various types of electronic devices capable of transmitting communications between the client devices 110 and the network 130, for example, an access point, a gateway (such as a Touchstone® TG3452 gateway), a router (such as a wireless router and a mobile hotspot router), and a home network controller. Note that the type of electronic device 120 is not specifically limited in the present disclosure.

In some embodiments, the network 130 may include various networks, such as a wide area network (WAN), a local area network (LAN), a wireless network, a mobile network, an optical fiber network, the Internet, etc. Note that the type of network 130 is not specifically limited in the present disclosure.

In a network environment 100 such as that shown in FIG. 1, if client devices that should remain connected to the network are disconnected from the network, it is very inconvenient when a user needs to remotely control/use these client devices. In the prior art, upon the connection between a client device and the network being disconnected, it is difficult for the user to actively discover such a failure in time, and thus it is difficult to restore the connection therebetween in time. Therefore, in view of these problems, the embodiments of the present disclosure use an electronic device to monitor a client device's connection state and send an alert to a user when it is detected that the client device is offline, thereby assisting in maintaining the network connection of the client device in time, and making it convenient for the user to control the client device whenever and wherever desired.

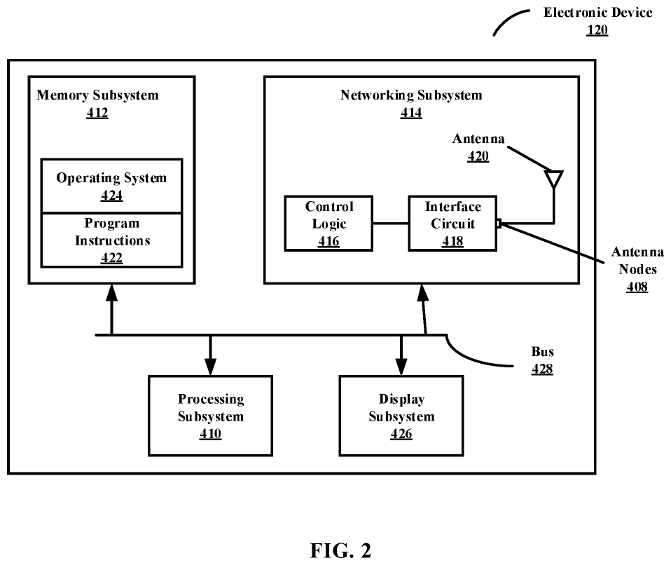

An embodiment of the electronic device 120 (as shown in FIG. 1) that is capable of performing at least some operations in communication technology will be described with reference to FIG. 2. FIG. 2 is a schematic diagram illustrating the electronic device 120 according to an embodiment of the present disclosure. The electronic device 120 may include a processing subsystem 410, a memory subsystem 412, and a networking subsystem 414.

The processing subsystem 410 includes one or more devices configured to perform computational operations. The processing subsystem 410 provides various functions of the electronic device 120. In some embodiments, the processing subsystem 410 is configured to perform operations for monitoring the connection state of one or more client devices 110. For example, the processing subsystem 410 may include one or more microprocessors, ASICs, microcontrollers, programmable logic devices, graphics processor units (GPUs), and/or one or more digital signal processors (DSPs). The processing subsystem 410 can execute various program instructions stored in the memory subsystem 412 to perform corresponding operations.

The memory subsystem 412 includes one or more devices for storing data and/or instructions for the processing subsystem 410 and the networking subsystem 414. For example, the memory subsystem 412 can include dynamic random access memory (DRAM), static random access memory (SRAM), and/or other types of memory (which collectively or individually are sometimes referred to as a ‘computer-readable storage medium’). In some embodiments, instructions for the processing subsystem 410 in memory subsystem 412 include: one or more program modules or sets of instructions (such as program instructions 422 or operating system 424), which may be executed by the processing subsystem 410. Note that the one or more computer programs may constitute a computer-program mechanism. Moreover, instructions in the various modules in the memory subsystem 412 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by the processing subsystem 410.

In addition, the memory subsystem 412 can include mechanisms for controlling access to the memory. In some embodiments, the memory subsystem 412 includes a memory hierarchy that comprises one or more caches coupled to a memory in the electronic device 120. In some of these embodiments, one or more of the caches is located in the processing subsystem 410.

In some embodiments, the memory subsystem 412 is coupled to one or more high-capacity mass-storage devices (not shown). For example, the memory subsystem 412 can be coupled to a magnetic or optical drive, a solid-state drive, or another type of mass-storage device. In these embodiments, the memory subsystem 412 can be used by the electronic device 120 as fast-access storage for often-used data, while the mass-storage device is used to store less frequently used data.

The networking subsystem 414 includes one or more devices configured to couple to and communicate on a wired and/or wireless network (such as the network 130 shown in FIG. 1) (i.e., to perform network operations), including: control logic 416, an interface circuit 418 and one or more antennas 420 (or antenna elements). (While FIG. 2 includes one or more antennas 420, in some embodiments, the electronic device 120 includes one or more nodes, such as nodes 408, which can be coupled to the one or more antennas 420. Thus, the electronic device 120 may or may not include the one or more antennas 420.) For example, the networking subsystem 414 can include a Bluetooth networking system, a cellular networking system (e.g., a 3G/4G/5G network such as UMTS, LTE, etc.), a USB networking system, a networking system based on the standards described in IEEE 802.11 (e.g., a Wi-Fi networking system), an Ethernet networking system, and/or another networking system.

In some embodiments, a transmit antenna radiation pattern of the electronic device 120 may be adapted or changed using pattern shapers (such as reflectors) in one or more antennas 420 (or antenna elements), which can be independently and selectively electrically coupled to ground to steer the transmit antenna radiation pattern in different directions. Thus, if one or more antennas 420 includes N antenna-radiation-pattern shapers, the one or more antennas 420 may have 2N different antenna-radiation-pattern configurations. More generally, a given antenna radiation pattern may include amplitudes and/or phases of signals that specify a direction of the main or primary lobe of the given antenna radiation pattern, as well as so-called ‘exclusion regions’ or ‘exclusion zones’ (which are sometimes referred to as ‘notches’ or ‘nulls’). Note that an exclusion zone of the given antenna radiation pattern includes a low-intensity region of the given antenna radiation pattern. While the intensity is not necessarily zero in the exclusion zone, it may be below a threshold, such as 4 dB or lower than the peak gain of the given antenna radiation pattern. Thus, the given antenna radiation pattern may include a local maximum (e.g., a primary beam) that directs gain in the direction of an electronic device that is of interest, and one or more local minima that reduce gain in the direction of other electronic devices that are not of interest. In this way, the given antenna radiation pattern may be selected so that communication that is undesirable (such as with the other electronic devices) is avoided to reduce or eliminate adverse effects, such as interference or crosstalk.

The networking subsystem 414 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, the electronic device 120 may use the mechanisms in the networking subsystem 414 for performing simple wireless communication between the electronic devices, e.g., transmitting frames and/or scanning for frames transmitted by other electronic devices.

Within the electronic device 120, the processing subsystem 410, the memory subsystem 412, and the networking subsystem 414 are coupled together using a bus 428. The bus 428 may include an electrical, optical, and/or electro-optical connection that the subsystems can use to communicate commands and data among one another. Although only one bus 428 is shown for clarity, different embodiments can include a different number or configuration of electrical, optical, and/or electro-optical connections among the subsystems.

In some embodiments, the electronic device 120 includes a display subsystem 426 for displaying information on a display, which may include a display driver and the display, such as a liquid-crystal display, a multi-touch touchscreen, etc.

The electronic device 120 can be (or can be included in) any electronic device with at least one network interface. For example, the electronic device 120 can be (or can be included in): a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, an access point, test equipment, and/or another electronic device.

Although specific components are used to describe the electronic device 120, in alternative embodiments, different components and/or subsystems may be present in the electronic device 120. For example, the electronic device 120 may include one or more additional processing subsystems, memory subsystems, networking subsystems, and/or display subsystems.

Additionally, one or more of the subsystems may not be present in the electronic device 120. Moreover, in some embodiments, the electronic device 120 may include one or more additional subsystems that are not shown in FIG. 2. Also, although separate subsystems are shown in FIG. 2, in some embodiments some or all of a given subsystem or component can be integrated into one or more of the other subsystems or component(s) in the electronic device 120. For example, in some embodiments the program instructions 422 are included in an operating system 424 and/or control logic 416 is included in an interface circuit 418.

Moreover, the circuits and components in the electronic device 120 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’ or a ‘means for communication’) may implement some or all of the functionality of the networking subsystem 414. The integrated circuit may include hardware and/or software mechanisms that are used for transmitting wireless signals from the electronic device 120 and receiving signals at the electronic device 120 from other electronic devices. Aside from the mechanisms herein described, radios are generally known in the art and hence are not described in detail. In general, the networking subsystem 414 and/or the integrated circuit can include any number of radios. Note that the radios in multiple-radio embodiments function in a similar way to the described single-radio embodiments.

In some embodiments, the networking subsystem 414 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals.)

In some embodiments, the processing subsystem 410 is configured to perform operations for monitoring the connection state of one or more client devices 110, the operations including: determining whether a client device needs to be always online according to a predetermined rule; in response to determining that the client device needs to be always online, adding the client device to a first list; monitoring a connection state of a listed client device in the first list; and sending an alert to the user in response to determining that the listed client device in the first list is offline. In some embodiments, the first list is stored in the electronic device 120.

In some embodiments, wherein the determining whether the client device needs to be always online according to a predetermined rule may include: recording an online time of the client device; and determining that the client device needs to be always online if the online time of the client device exceeds a predetermined threshold. In some embodiments, for example, an electronic device (such as the gateway) records the online times of a client device. If the online time of the client device exceeds 7*24 hours, it is determined that the client device needs to be always online.

In some embodiments, wherein the determining whether the client device needs to be always online according to a predetermined rule may include: acquiring device information of the client device; and determining whether the client device needs to be always online based on the acquired device information. In some embodiments, whether a client device needs to be always online can be determined based on the client device's host name, media access control (MAC) address, etc. For example, if the client device's host name is “surveillance camera of user A”, and the MAC address belongs to the residence of user A, it can be determined for user A that the client device needs to be always online.

In some embodiments, wherein the determining whether the client device needs to be always online according to a predetermined rule may include: receiving an input from the user, the input indicating whether the client device needs to be always online. In some embodiments, when client devices are connected to a network through an electronic device, the electronic device may receive, from a user, an input indicating that a client device needs to be always online.

In some embodiments, the sending of an alert to a user may comprise but not limited to: sending an alert to the user through one or more of an email, a voice message, a mobile application, or a call. The alarm may include information indicating that the client device is offline. Upon receiving the alert, the user can restore the connection of the client device according to the alert information.

In some embodiments, the processing subsystem 410 may be further configured to cause the electronic device 120 to perform the following operations: receiving an indication to enable or disable monitoring of a connection state of a client device. The indication is given by one or more of: setting the electronic device 120 on a setup webpage or an application, or notifying a network service provider through protocol signaling.

For example, the user may log in a function setup page of the electronic device 120 that is displayed on a browser, and indicate whether to enable or disable monitoring of the connection state of the client devices through a graphical user interface (GUI) on the function setup page. As another example, an APP installed on a portable computing device can be used to indicate whether to enable or disable monitoring of the connection state of the client devices. For another example, a network service provider may be notified via signaling of any protocol to indicate whether to enable or disable monitoring of the connection state of the client devices, where the protocol signaling may be at least one of, for example, Simple Network Management Protocol (SNMP) or TR-069 protocol signaling. Note that the type of protocol signaling is not limited in the present disclosure.

In some embodiments, the client devices 110 may include, but are not limited to: a smart stereo system, a webcam, a lighting device, a smart refrigerator, a smart air conditioner, or any other type of smart home equipment or smart office equipment.

In some embodiments, wherein the client device 110 needs to be always online includes one of: the client device 110 needs to be always connected to a Wide Area Network (WAN), the client device 110 needs to be always connected to a Local Area Network (LAN), and the monitoring of the connection state respectively includes monitoring whether the listed client device is connected to the WAN or monitoring whether the listed client device is connected to the LAN.

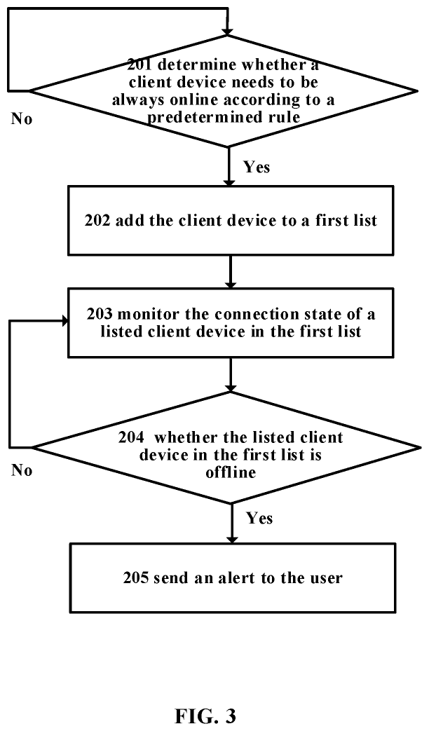

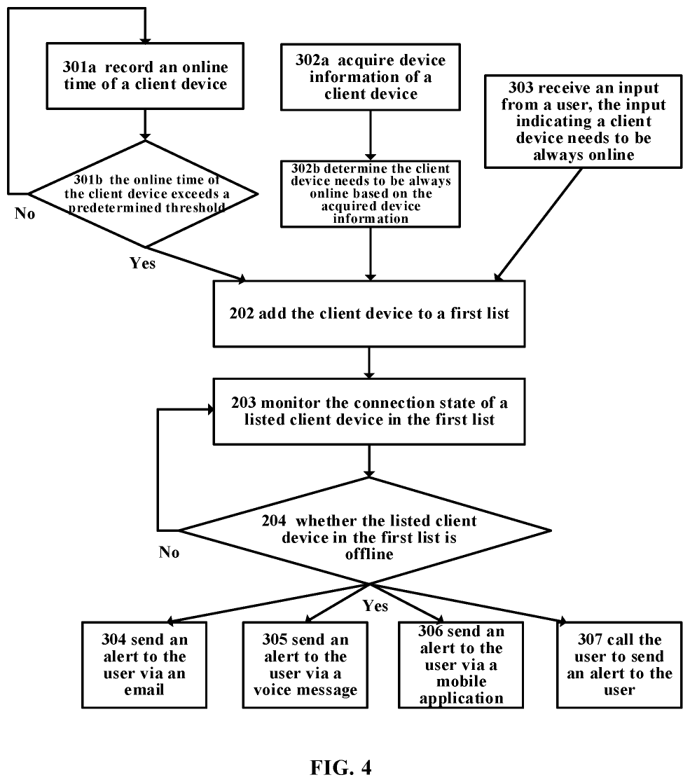

An exemplary method for monitoring a client device's connection state according to an embodiment of the present disclosure will be described below with reference to FIGS. 3 and 4. FIG. 3 shows a method 200 for monitoring a client device's connection state according to an embodiment of the present disclosure. FIG. 4 shows a method 300 for monitoring a client device's connection state according to an embodiment of the present disclosure. Note that both the methods 200 and 300 herein can be performed by the electronic device 120 shown in FIG. 1, and the client devices can be the client devices 110 shown in FIG. 1.

In some embodiments, the method 200 may include, in operation 201, determining whether a client device (e.g., the client device 110a, 110b, or 110c) needs to be always online according to a predetermined rule. In some embodiments, wherein the client device needs to be always online includes one of: the client device needs to be always connected to a Wide Area Network (WAN), the client device needs to be always connected to a Local Area Network (LAN). If so, the process proceeds to operation 202; otherwise, the process returns to operation 201, determining, for another client device, whether the other client device needs to be always online according to a predetermined rule.

The operation 201 in the method 200, i.e., how to determine whether a client device needs to be always online according to a predetermined rule, will be specifically described below with reference to the method 300 of FIG. 4. Note that how to determine whether a client device needs to be always online according to a predetermined rule is not limited to the methods described below.

In some embodiments, the determining whether the client device needs to be always online according to a predetermined rule may include: in operation 301a, recording an online time of the client device; and in operation 301b, determining whether the online time of the client device exceeds a predetermined threshold. It is determined that the client device needs to be always online if its online time exceeds the predetermined threshold, and the process proceeds to operation 202; otherwise, the process returns to operation 301a, and records, for another client device, an online time of the client device, and in operation 301b, determining whether the online time of the other client device exceeds the predetermined threshold, so as to determine whether the other client device needs to be always online. In some embodiments, for example, the electronic device 120 records the online times of client devices 110a, 110b, and 110c. If the online time of a client device (such as the client device 110a) exceeds 7*24 hours, it is determined that the corresponding client device (e.g., client device 110a) needs to be always online.

In some embodiments, the determining whether the client device needs to be always online according to a predetermined rule may further include: in operation 302a, acquiring device information of the client device; and in operation 302b, determining whether the client device needs to be always online based on the acquired device information. If it is determined that the client device needs to be always online, the process proceeds to operation 202; otherwise, the process returns to determine, for another client device, whether the other client device needs to be always online. In some embodiments, whether a client device needs to be always online can be determined based on the client device's host name, media access control (MAC) address, etc. For example, if the client device's host name is “surveillance camera of user A”, and the MAC address belongs to the residence of user A, it can be determined for user A that the client device needs to be always online.

In some embodiments, the determining whether the client device needs to be always online according to a predetermined rule may further include: in operation 303, receiving an input from a user, the input indicating whether the client device needs to be always online. If the input indicates that the client device needs to be always online, the process proceeds to operation 202; otherwise, the process returns to determine, for another client device, whether the other client device needs to be always online. In some embodiments, when client devices 110 are connected to the network 130 through the electronic device 120, the electronic device 120 may receive, from a user, an input indicating that the client device needs to be always online.

Referring back to FIG. 3, in some embodiments, the method 200 may comprise, in operation 202, in response to determining that the client device needs to be always online, adding the client device to a first list. In some embodiments, the first list may be stored in the electronic device 120. For example, in some embodiments, if it is determined that the client devices 110a and 110c need to be always online, the client devices 110a and 110c are added to a first list in operation 202.

In some embodiments, the method 200 may comprise, in operation 203, monitoring the connection state of a listed client device in the first list. For example, in some embodiments, the electronic device 120 monitors the connection state of the client devices 110a and 110c in the first list. In some embodiments, the monitoring of the connection state respectively includes monitoring whether the listed client device is connected to the WAN or monitoring whether the listed client device is connected to the LAN

In some embodiments, the method 200 may include determining whether the listed client device in the first list is offline in operation 204; if it is offline, the process proceeds to operation 205 to send an alert to the user; otherwise, the process returns to operation 203, and monitors the connection state of the client devices in the first list.

The operation 205 in the method 200, i.e., how to send an alert to a user will be described in detail below with reference to the method 300 of FIG. 4. Note that how to send an alert to a user is not limited to the following methods.

In some embodiments, the sending of an alert to a user may comprise one or more of: in operation 304, sending an alert to the user via an email by the electronic device 120; or in operation 305, sending an alert to the user via a voice message by the electronic device 120; or in operation 306, sending an alert to the user via a mobile application; or in operation 307, calling the user by the electronic device 120 to send an alert to the user. The alarm may include information indicating that the client device is offline. Upon receiving the alert, the user can restore the connection of the client device according to the alert information.

In some embodiments, the method 200 or 300 may further comprise receiving an indication to enable or disable monitoring of the connection state of the client devices, the indication being given by one or more of: setting the electronic device 120 on a setup webpage or application, or notifying a network service provider through protocol signaling.

For example, the user may log in a function setup page of the electronic device 120 that is displayed on a browser, and indicate whether to enable or disable monitoring of the connection state of the client devices through a graphical user interface (GUI) on the function setup page. As another example, an application (APP) installed on a portable computing device can be used to indicate whether to enable or disable monitoring of the connection state of the client devices. For another example, a network service provider may be notified via signaling of any protocol to indicate whether to enable or disable monitoring of the connection state of the client devices, wherein the protocol signaling may be at least one of, for example, Simple Network Management Protocol (SNMP) or TR-069 protocol signaling. Note that the type of protocol signaling is not limited in the present disclosure.

In some embodiments, in the method 200 or 300, the client devices 110 may include, but are not limited to: a smart stereo system, a webcam, a lighting device, a smart refrigerator, a smart air conditioner, or any other type of smart home equipment or smart office equipment.

In some embodiments, the method 200 or 300 may be performed by the electronic device 120, such as a gateway, a router, or a home network controller.

While the preceding discussion used Wi-Fi and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 422, operating system 424 (such as a driver for the interface circuit 418) or in firmware in the interface circuit 418. Alternatively or additionally, at least some of the operations in the communication techniques may be implemented in a physical layer, such as hardware in the interface circuit 418.

According to an embodiment of the present disclosure, an electronic device can be used to monitor a connection state of a client device and send an alert to the user when it is detected that the client device is offline, thereby assisting in maintaining the network connection of a client device in time, and making it convenient for the user to control the client devices whenever and wherever desired.

The present disclosure may be implemented as any combination of an apparatus, a system, an integrated circuit, and a computer program on a non-transitory computer readable recording medium. The one more processors may be implemented as an integrated circuit (IC), an application specific integrated circuit (ASIC), or large scale integrated circuit (LSI), system LSI, super LSI, or ultra LSI components that perform a part or all of the functions described in the present disclosure.

The present disclosure includes the use of software, applications, computer programs, or algorithms. The software, applications, computer programs, or algorithms can be stored on a non-transitory computer-readable medium for causing a computer, such as the one or more processors, to execute the steps described above and in the drawings. For example, the one or more memories stores software or algorithms with executable instructions and the one or more processors can execute a set of instructions of the software or algorithms in association for providing monitoring in any number of wireless networks in accordance with the embodiments described in the present disclosure.

The software and computer programs, which can also be referred to as programs, software applications, applications, components, or code, include machine instructions for a programmable processor, and can be implemented in a high-level procedural language, an object-oriented programming language, a functional programming language, a logical programming language, or an assembly language or machine language. The term ‘computer-readable recording medium’ refers to any computer program product, apparatus or device, such as a magnetic disk, optical disk, solid-state storage device, memory, and programmable logic devices (PLDs), used to provide machine instructions or data to a programmable data processor, including a computer-readable recording medium that receives machine instructions as a computer-readable signal.

By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Use of the phrases “capable of,” “capable to,” “operable to,” or “configured to” in one or more embodiments, refers to some apparatus, logic, hardware, and/or element designed in such a way to enable use of the apparatus, logic, hardware, and/or element in a specified manner. The subject matter of the present disclosure is provided as examples of apparatus, systems, methods, and programs for performing the features described in the present disclosure. However, further features or variations are contemplated in addition to the features described above. It is contemplated that the implementation of the components and functions of the present disclosure can be done with any newly arising technology that may replace any of the above implemented technologies.

Additionally, the above description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, features described with respect to certain embodiments may be combined in other embodiments.

Similarly, while operations are depicted in the drawings in a particular order, this should not be understood as requiring that such operations be performed in the particular order shown or in sequential order, or that all illustrated operations be performed, to achieve desirable results. In some cases, multitasking and parallel processing may be advantageous.

1. An electronic device, comprising:
a memory having instructions stored thereon;
a processor configured to execute the instructions stored on the memory to cause the electronic device to perform operations comprising:
determining whether a client device needs to be always online according to a predetermined rule;
in response to determining that the client device needs to be always online, adding the client device to a first list;
monitoring a connection state of a listed client device in the first list, wherein the monitoring comprises configuring one or more radios of the electronic device to receive a signal from the client device and performing one or more processing operations on the received signal; and
sending an alert to a user in response to determining that the listed client device in the first list is offline.

2. The electronic device of claim 1, wherein the determining whether the client device needs to be always online according to a predetermined rule includes:
recording an online time of the client device; and
determining that the client device needs to be always online if the online time of the client device exceeds a predetermined threshold.

3. The electronic device of claim 1, wherein the determining whether the client device needs to be always online according to a predetermined rule includes:
acquiring device information of the client device; and
determining whether the client device needs to be always online based on the acquired device information.

4. The electronic device of claim 1, wherein the determining whether the client device needs to be always online according to a predetermined rule includes:
receiving an input from a user, the input indicating whether the client device needs to be always online.

5. The electronic device of claim 1, wherein the sending of an alert to the user comprises: sending an alert to the user through one or more of an email, a voice message, a mobile application, or a call.

6. The electronic device of claim 1, wherein the processor further causes the electronic device to perform the following operations: receiving an indication to enable or disable monitoring of a connection state of client devices, the indication being given by one or more of: setting the electronic device on a setup webpage or application, or notifying a network service provider through protocol signaling.

7. The electronic device of claim 1, wherein the client device includes one or more of: a smart stereo system, a webcam, a lighting device, a smart refrigerator, or a smart air conditioner.

8. The electronic device of claim 1, wherein the client device needs to be always online includes one of: the client device needs to be always connected to a Wide Area Network (WAN), the client device needs to be always connected to a Local Area Network (LAN), and the monitoring of the connection state respectively includes monitoring whether the listed client device is connected to the WAN or monitoring whether the listed client device is connected to the LAN.

9. A method for monitoring a connection state of a client device, the method comprising:
determining whether a client device needs to be always online according to a predetermined rule;
in response to determining that the client device needs to be always online, adding the client device to a first list;
monitoring a connection state of a listed client device in the first list, wherein the monitoring comprises configuring one or more radios of the electronic device to receive a signal from the client device and performing one or more processing operations on the received signal; and
sending an alert to the user in response to determining that the listed client device in the first list is offline;
wherein the method is performed by an electronic device.

10. The method of claim 9, wherein the determining whether the client device needs to be always online according to a predetermined rule includes:
recording an online time of the client device; and
determining that the client device needs to be always online if the online time of the client device exceeds a predetermined threshold.

11. The method of claim 9, wherein the determining whether the client device needs to be always online according to a predetermined rule includes:
acquiring device information of the client device; and
determining whether the client device needs to be always online based on the acquired device information.

12. The method of claim 9, wherein the determining whether the client device needs to be always online according to a predetermined rule includes:
receiving an input from a user, the input indicating whether the client device needs to be always online.

13. The method of claim 9, wherein the sending of an alert to the user comprises: sending an alert to the user through one or more of an email, a voice message, a mobile application, or a call.

14. The method of claim 9, further comprising receiving an indication to enable or disable monitoring of a connection state of client devices, the indication being given by one or more of: setting the electronic device on a setup webpage or application, or notifying a network service provider through protocol signaling.

15. The method of claim 9, wherein the client devices include one or more of: a smart stereo system, a webcam, a lighting device, a smart refrigerator, or a smart air conditioner.

16. The method of claim 9, wherein the client device needs to be always online includes one of: the client device needs to be always connected to a Wide Area Network (WAN), the client device needs to be always connected to a Local Area Network (LAN), and the monitoring of the connection state respectively includes monitoring whether the listed client device is connected to the WAN or monitoring whether the listed client device is connected to the LAN.

17. A non-transitory computer-readable medium having instructions stored thereon that, when executed by a processor of an electronic device, cause the processor to perform operations comprising:
determining whether a client device needs to be always online according to a predetermined rule;
in response to determining that the client device needs to be always online, adding the client device to a first list;
monitoring a connection state of a listed client device in the first list, wherein the monitoring comprises configuring one or more radios of the electronic device to receive a signal from the client device and performing one or more processing operations on the received signal; and
sending an alert to the user in response to determining that the listed client device in the first list is offline.

18. The non-transitory computer-readable medium of claim 17, wherein the determining whether the client device needs to be always online according to a predetermined rule includes at least one of:
recording an online time of the client device and determining that the client device needs to be always online if the online time of the client device exceeds a predetermined threshold;
acquiring device information of the client device and determining whether the client device needs to be always online based on the acquired device information;
receiving an input from a user, the input indicating whether the client device needs to be always online.

19. The non-transitory computer-readable medium of claim 17, wherein the sending of an alert to the user comprises: sending an alert to the user through one or more of an email, a voice message, a mobile application or a call.

20. The non-transitory computer-readable medium according of claim 17, further comprising instructions that cause the processor to perform the following operations: receiving an indication to enable or disable monitoring of a connection state of client devices, the indication being given by one or more of: setting the electronic device on a setup webpage or application, or notifying a network service provider through protocol signaling.
